(19) United States
(12) Patent Application Publication
(10) Pub. No.: US 2015/0027060 A1
(43) Pub. Date: Jan. 29, 2015

(54) Hands-Free Safety Gate

(71) Applicants: Mark J. Sousa, Hope, RI (US); Brian Sundberg, Chester, NH (US); Christopher C. Briden, Coventry, RI (US); Steven L. Torosian, York, ME (US)

(72) Inventors: Mark J. Sousa, Hope, RI (US); Brian Sundberg, Chester, NH (US); Christopher C. Briden, Coventry, RI (US); Steven L. Torosian, York, ME (US)

(21) Appl. No.: 13/950,396

(22) Filed: Jul. 25, 2013

(51) Int. Cl. E06B 11/02; E05B 65/00; E06B 9/04

(52) U.S. Cl. CPC E06B 11/022; E06B 9/04; E05B 65/0007; E05B 65/0014
USPC 49/394

(57) ABSTRACT

A child safety gate includes a frame having a first side and a second side configured to be removably mounted to opposing sides of a passageway. The gate further includes a door pivotably coupled to the first side and releasably coupled to the second side and a release mechanism coupled to the first side of the frame and pivotably coupled to the door. The release mechanism includes a foot pedal and is configured to move the door from a closed and locked position to an open position when the foot pedal is sufficiently actuated.

### TECHNICAL FIELD

The invention relates to child safety gates, and more specifically to child safety gates that are capable of being opened without using the hands.

### BACKGROUND

Child safety gates are used to block passageways so that infants and toddlers are prevented from leaving designated areas or from accessing unsupervised areas. The gates, however, need to allow relatively easy access through the passageway for authorized individuals such as older children or adults. In some cases, the safety gates are difficult to open or require one or two hands to remove the barrier to the passageway, open the door or re-latch it closed.

### SUMMARY OF THE INVENTION

In accordance with one embodiment of the invention, a child safety gate includes a frame having first and second sides configured to be removably mounted to opposing sides of a passageway. The gate further includes a door pivotably coupled to the first side and releasably coupled to the second side and a release mechanism coupled to the first side of the frame and pivotably coupled to the door. The release mechanism includes a foot pedal and is configured to move the door from a closed and locked position to an open position when the foot pedal is sufficiently actuated.

In some embodiments, the child safety gate may be releasably coupled to the second side of the frame by a latch mechanism. The latch mechanism may include a hand release mechanism configured to move the door from the locked position to an unlocked position. The hand release mechanism may include a slider configured to move from a locked position to a released position, a rod configured to move in a substantially vertical direction, and an actuator movably coupled to the rod. The actuator may move the rod in the substantially vertical direction when the slider is in the released position. In addition, the actuator may be unable to move the rod in the substantially vertical direction when the slider is in the locked position. The release mechanism may be configured to move the door in a substantially vertical direction so as to allow the door to go from the locked position to an unlocked position. The release mechanism may include a spring configured to move the door from the open position to the closed and locked position. The frame may include a connecting member configured to couple the first side to the second side of the frame, and the release mechanism may be also coupled to the connecting member. The release mechanism may include two foot pedals disposed in opposing directions, and the second foot pedal may be configured to move the door from the closed and locked position to the open position when the second foot pedal is sufficiently actuated.

### BRIEF DESCRIPTION OF THE DRAWINGS

FIG. 1 schematically shows a perspective view of a child safety gate in a closed position according to embodiments of the present invention.

FIG. 2 schematically shows a perspective view of an upper latch with a hand release mechanism for a child safety gate in the closed position according to embodiments of the present invention.

FIG. 3 schematically shows a perspective view of a lower latch for a child safety gate in the closed position according to embodiments of the present invention.

FIG. 4 schematically shows a front view of a child safety gate in a closed and unlocked position according to embodiments of the present invention.

FIG. 5 schematically shows a perspective view of the lower latch for a child safety gate in the closed and unlocked position according to embodiments of the present invention.

FIG. 6 schematically shows a perspective view of a child safety gate in an open position according to embodiments of the present invention.

FIG. 7 schematically shows a front view of a release mechanism for a child safety gate in the released position when the pedal is partially depressed according to embodiments of the present invention.

FIG. 8 schematically shows a cross-sectional view of the release mechanism for a child safety gate in the released position when the pedal is partially depressed according to embodiments of the present invention.

FIG. 9 schematically shows a perspective view of the release mechanism for a child safety gate in the open position according to embodiments of the present invention.

FIG. 10 schematically shows a cross-sectional view of the release mechanism for a child safety gate in the open position according to embodiments of the present invention.

FIG. 11 schematically shows a perspective view of the upper latch with the hand release mechanism in the locked position and showing the inner components according to embodiments of the present invention.

FIG. 12 schematically shows a front view of the upper latch with the hand release mechanism in the locked position and showing the inner components according to embodiments of the present invention.

FIG. 13 schematically shows a perspective view of the upper latch with the hand release mechanism in the unlocked position according to embodiments of the present invention.

FIG. 14 schematically shows a front view of the upper latch with the hand release mechanism in the unlocked position according to embodiments of the present invention.

FIGS. 15-17 schematically show a perspective view of the upper latch during the gate closing process according to embodiments of the present invention.

### DETAILED DESCRIPTION

Various embodiments of the present invention provide a child safety gate that is capable of being opened without using the hands. The gate includes a frame configured to be removably mounted to opposing sides of a passageway, a door pivotably coupled to one side of the frame and releasably coupled to the other side of the frame, and a release mechanism coupled to one side of the frame and pivotably coupled to the door. The release mechanism includes a foot pedal and is configured to move the door from a closed and locked position to an open position when the foot pedal is sufficiently depressed or actuated. In addition, the gate includes a hand release mechanism so that the gate may be unlocked and opened by hand without using the release mechanism and its foot pedal. The safety gate prevents infants or toddlers from leaving a designated area while permitting relatively easy access through the passageway for adults. Details of illustrative embodiments are discussed below.

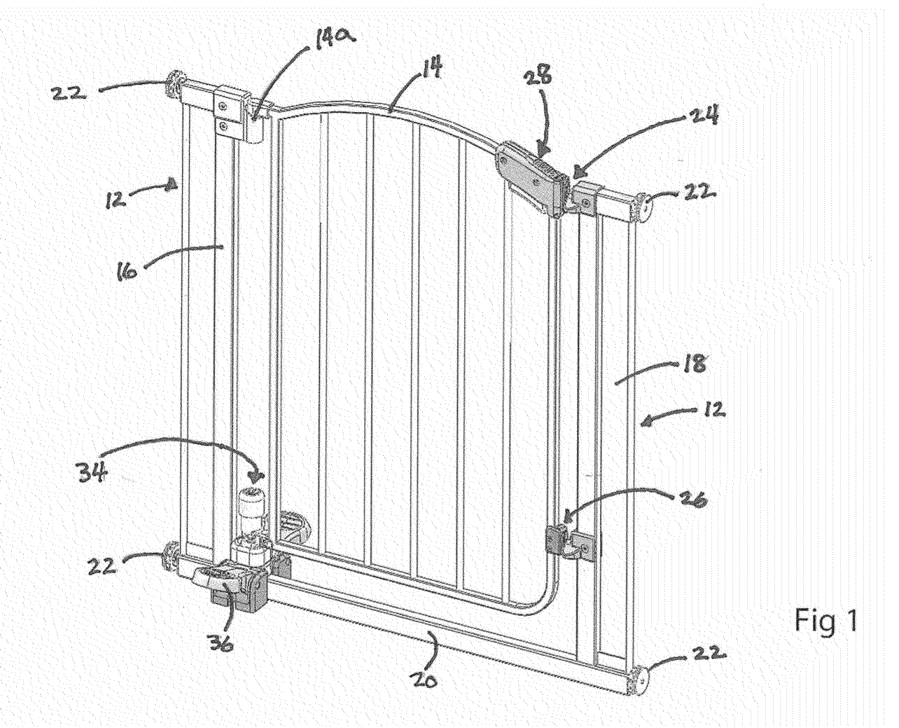

FIG. 1 schematically shows a child safety gate 10 that is configured to be removably mounted across a passageway according to embodiments of the present invention. The safety gate 10 includes a frame 12 and a door 14 mounted to the frame. The frame 12 includes a first side 16 that is removably mounted to one side of the passageway, a second side 18 that is removably mounted to the opposing side of the passageway, and a connecting member 20 that spans the passageway and connects the first and second sides together. The frame 12 may be adjusted to fit across passageways of varying dimensions. For example, adjustment members 22, that engage one side of the passageway, may be used on the first and second sides of the frame in order to increase or decrease the length of the frame.

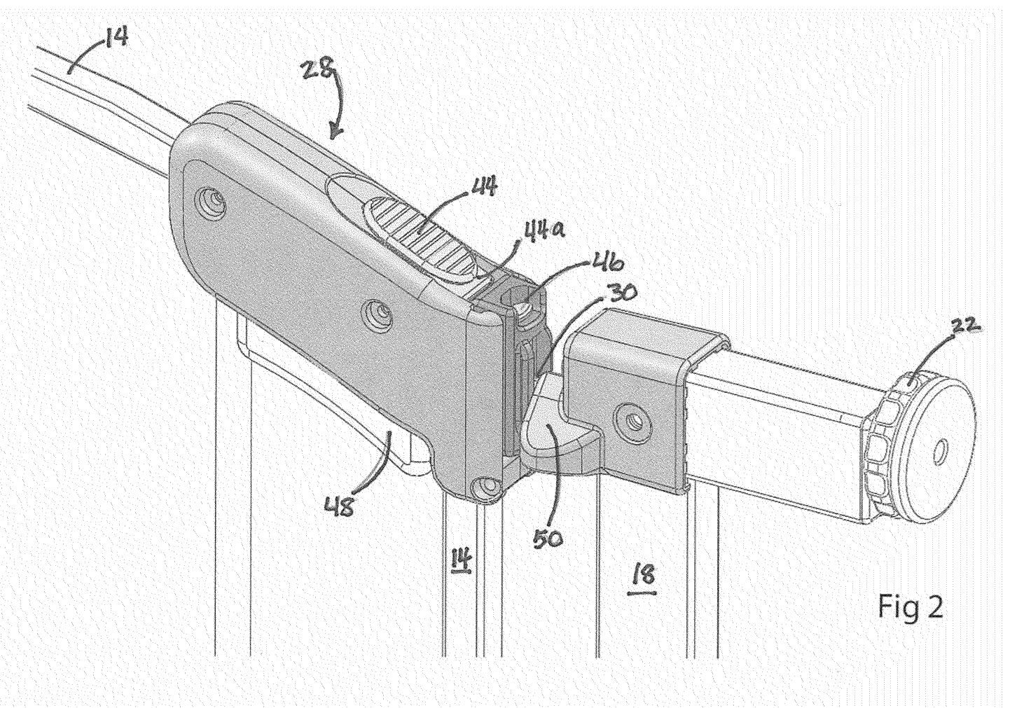

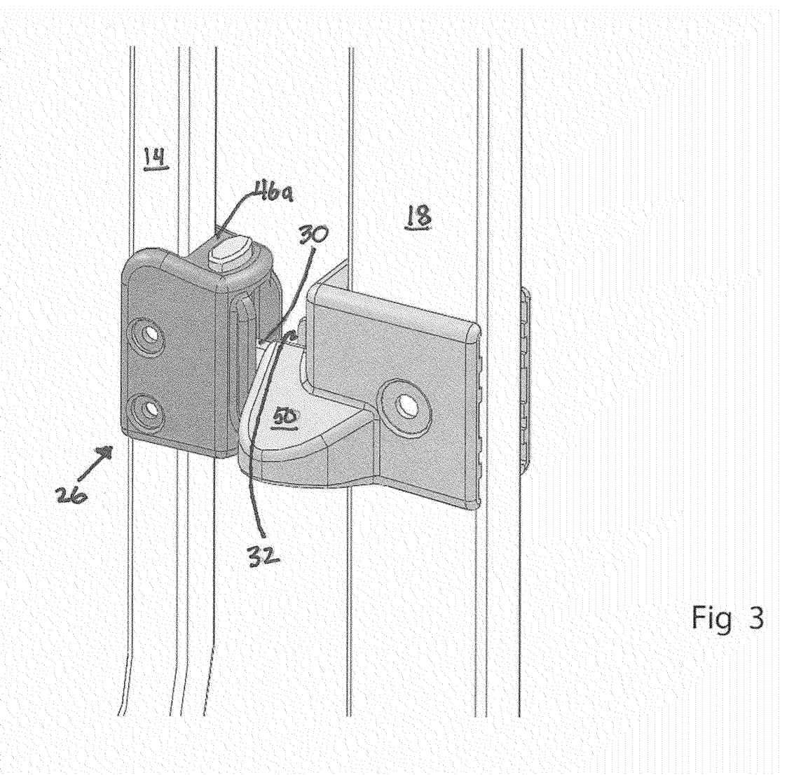

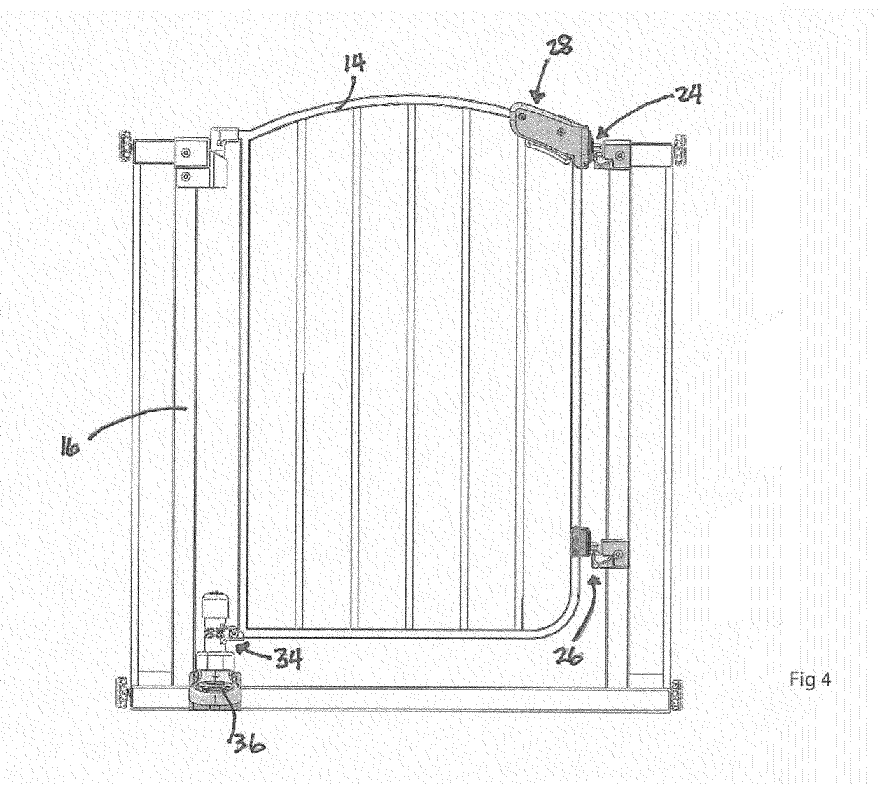

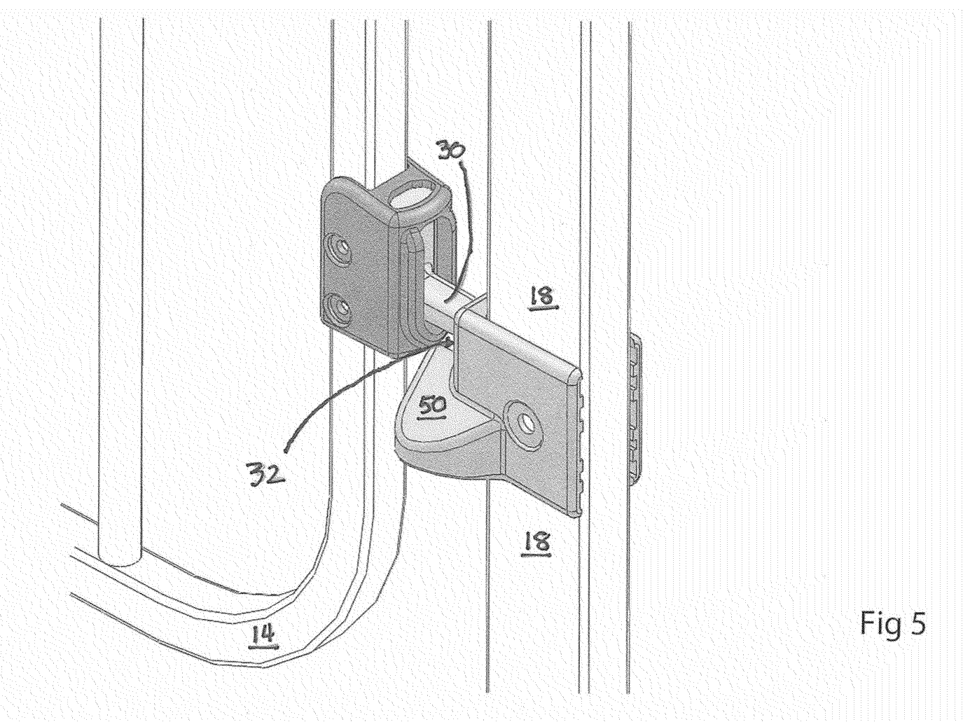

The door 14 is pivotably coupled to the first side 16 of the frame, e.g., at an upper location 14a, and releasably coupled to the second side 18 of the frame using one or more latch mechanisms 24, 26. For example, FIGS. 2 and 3 show close-up views of the upper latch 24 with a hand release mechanism 28 and the lower latch 26, respectively. Each of the latch mechanisms 24, 26 include a rod 30 movably coupled to the door 14 and a groove 32 configured to receive the rod 30 and coupled to the second side of the frame 18. The rod 30 is configured to move in a substantially vertical direction which allows the latch mechanisms 24, 26 to move from a locked position (such as shown in FIGS. 2 and 3), in which the rod 30 is positioned in the groove 32, to an unlocked position (such as shown in FIGS. 4 and 5), in which the rod 30 is out of the groove and able to move in a horizontal direction when the door 14 is opened, as will be described in more detail below.

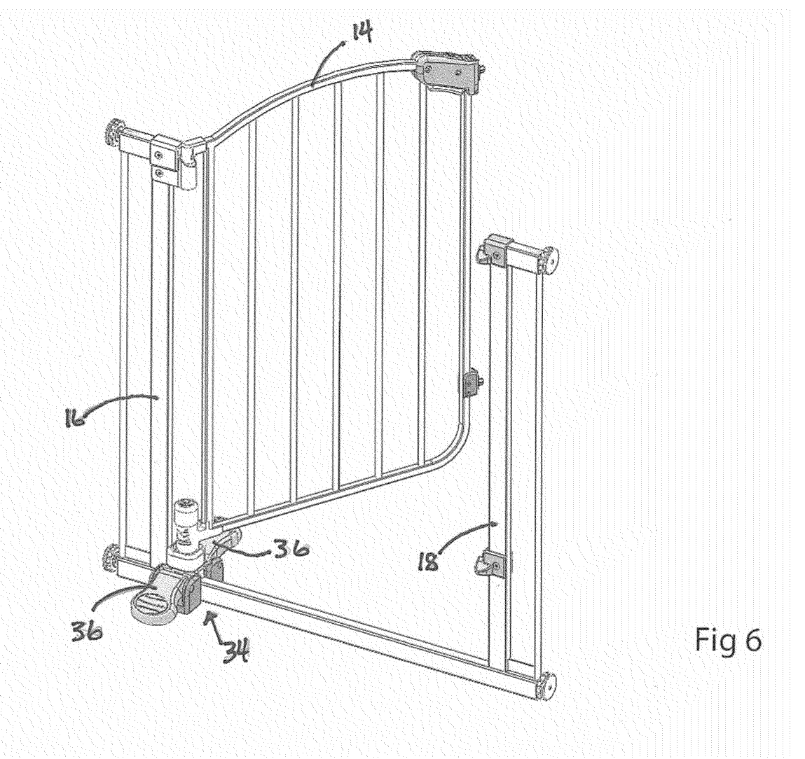

The safety gate 10 also includes a release mechanism 34 having one or more foot pedals 36 positioned on either side of the door 14 in opposing directions (See FIG. 6). The release mechanism 34 is coupled to the first side 16 of the frame and pivotably coupled to the door 14. During operation, the release mechanism 34 moves the door 14 from a closed and locked position (e.g., as shown in FIGS. 1-3) to a closed and unlocked position (e.g., as shown in FIGS. 4 and 5) and then to an open position (e.g., as shown in FIG. 6) when one of the foot pedals 36 is sufficiently actuated. The release mechanism 34 accomplishes this by initially moving the door 14 in a somewhat vertical direction to the unlocked position and then by moving the door 14 in a radial direction to the open position.

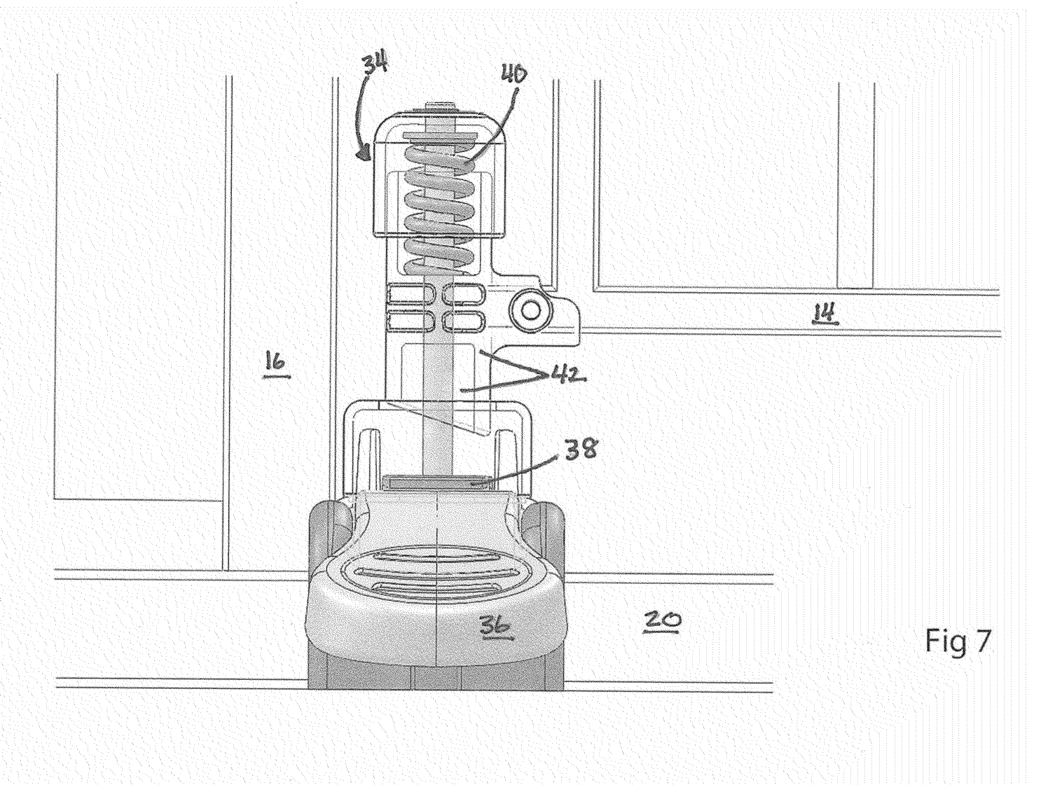

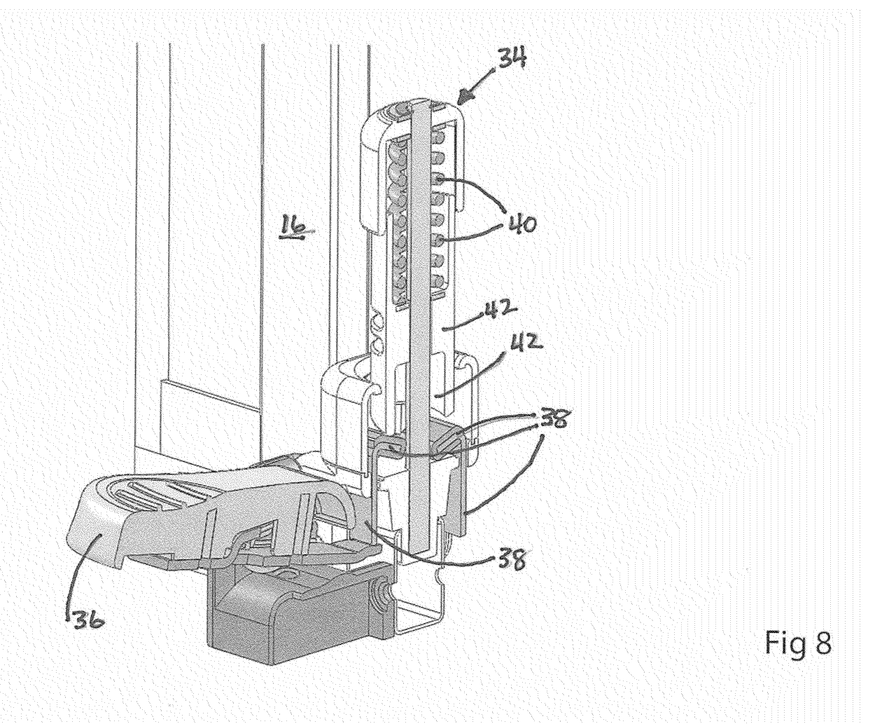

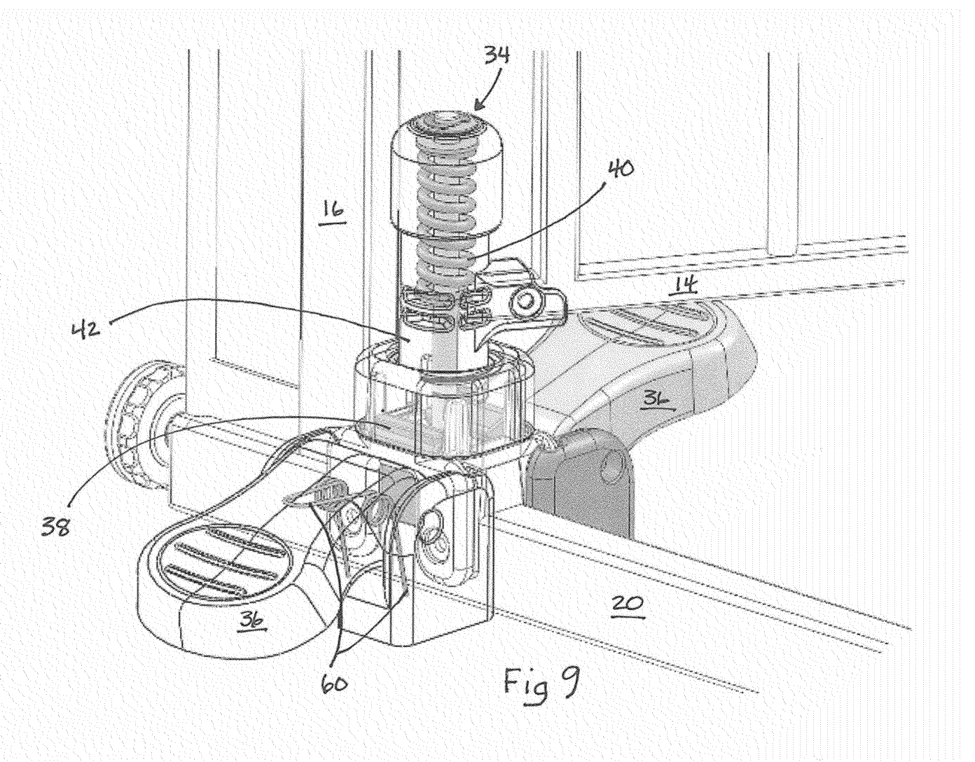

FIGS. 7-10 show close-up views of the release mechanism 34 with portions of it removed or made transparent in order to more fully describe its function during the various stages of opening the door 14. As shown in FIGS. 7 and 8, when the foot pedal 36 begins to be actuated or depressed with sufficient force by an individual, the action moves an opening member 38, which contacts a chamfered portion 42 of the release mechanism 34, initially moving a portion of the release mechanism 34 upward thus causing the door 14 to initially move in a somewhat vertical direction. When the door 14 moves with sufficient vertical motion, each rod 30 moves upward and out of each corresponding groove 32 so that the latch mechanisms 24, 26 are released or unlocked, such as shown in FIGS. 4 and 5. The upward motion also causes a load to be applied to a compression spring 40 in the release mechanism 34 and to a torsion spring 60 in the foot pedal 36. FIG. 9 shows a cross-sectional view of the release mechanism 34 with the foot pedal 36 on the left partially depressed and the foot pedal 36 on the right in the un-pressed position. The compression spring 40 and the torsion spring 60 cause the foot pedals 36 to be biased to the unpressed position.

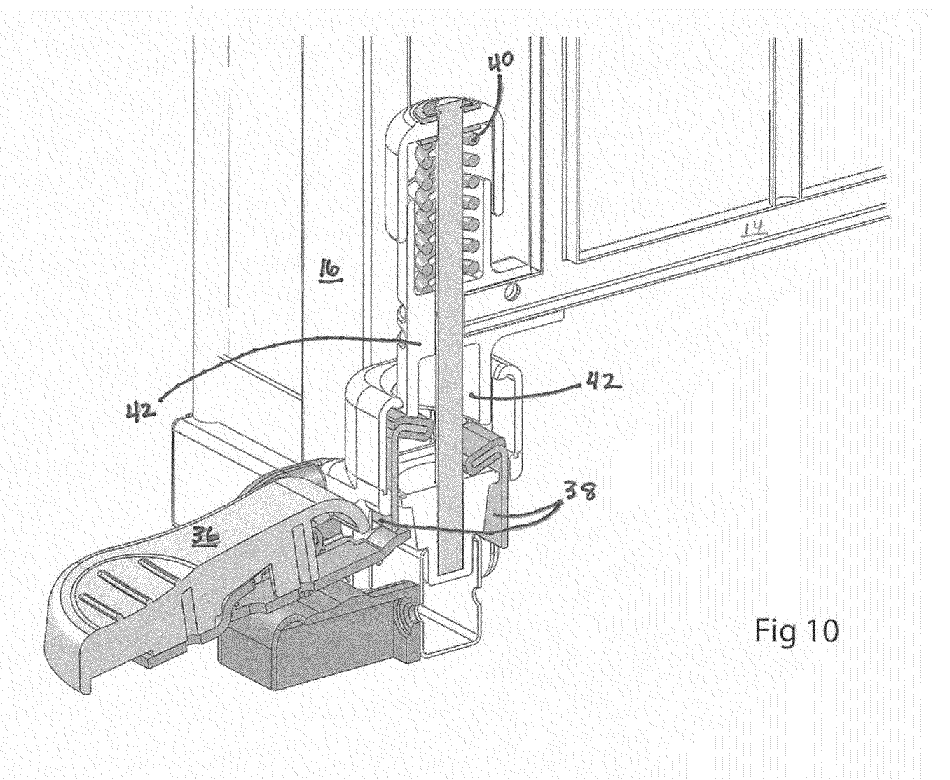

As shown in FIGS. 9 and 10, as the foot pedal 36 is depressed further, the opening member 38 continues to push upward on the chamfered member 42 which causes the door 14 to move in a radial direction. This radial motion causes the door 14, which is coupled to a portion of the release mechanism 34, to move to an open position (e.g., as shown in FIGS. 6, 9 and 10), and the direction depends on which foot pedal 36 is depressed, e.g., the door moves away from the depressed foot pedal, so that a person can readily go through the gate. The upward/radial motion also causes a further load to be applied to the spring 40, e.g., by compressing the spring further. When the individual going through the gate 10 releases the foot pedal 36 and the load is removed, the foot pedal 36 returns to the unpressed position due to the spring 40, causing the door 14 to return to the closed and locked position.

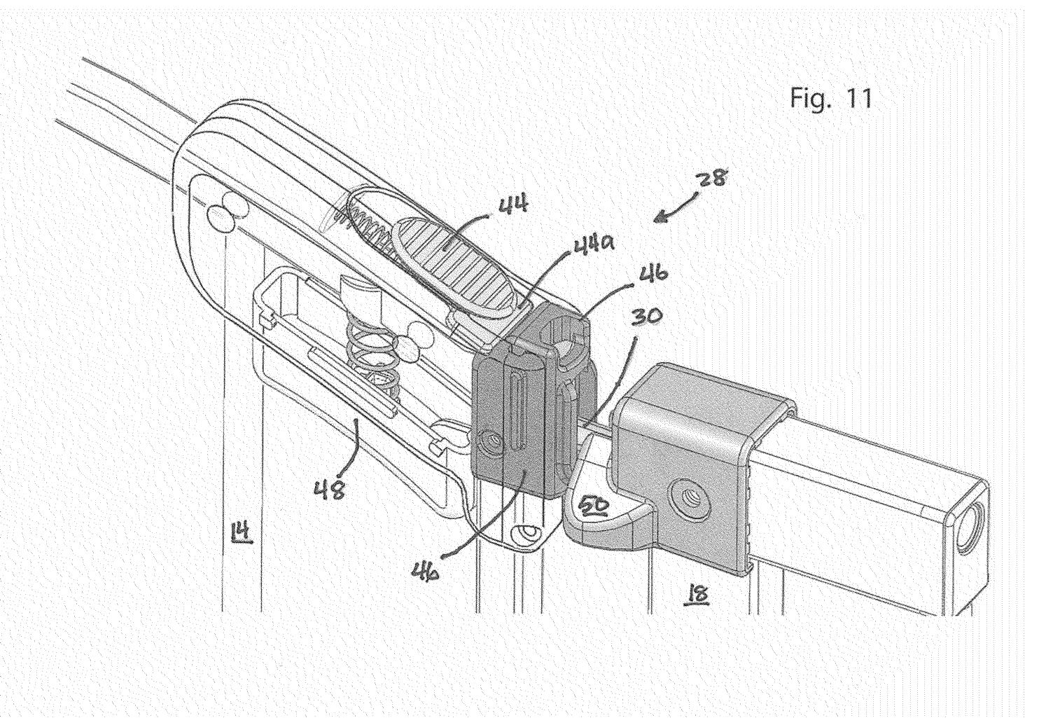

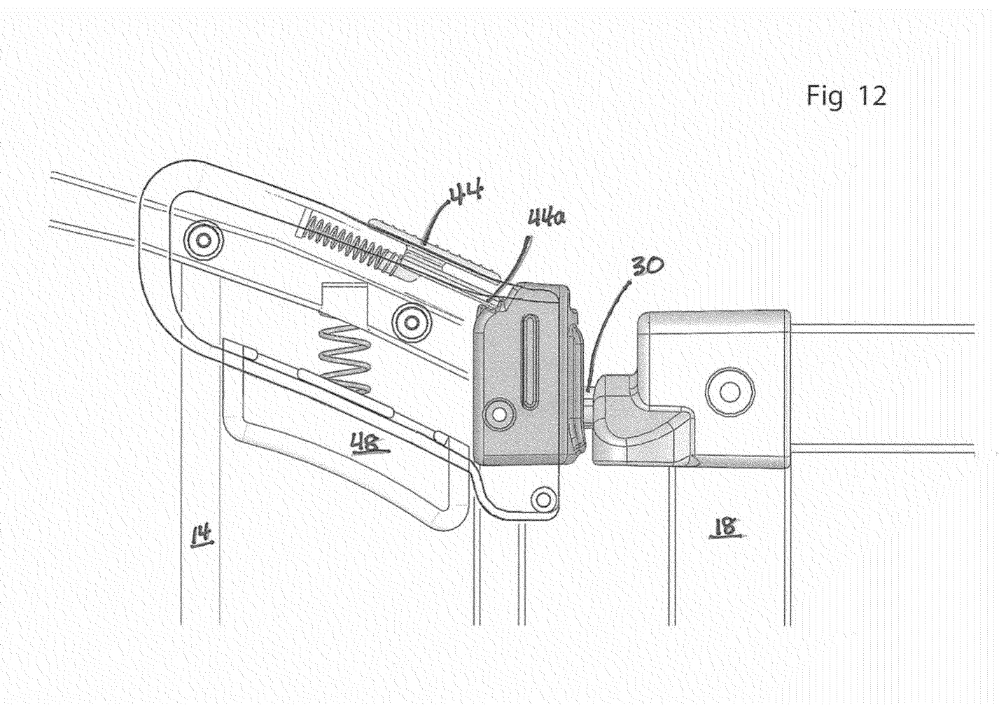

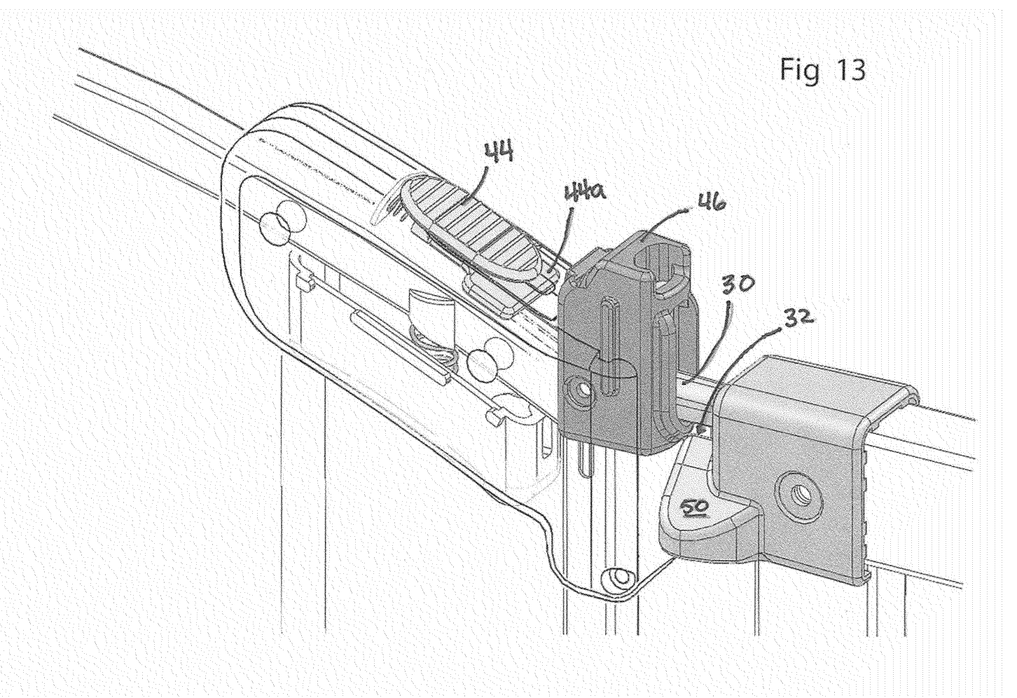

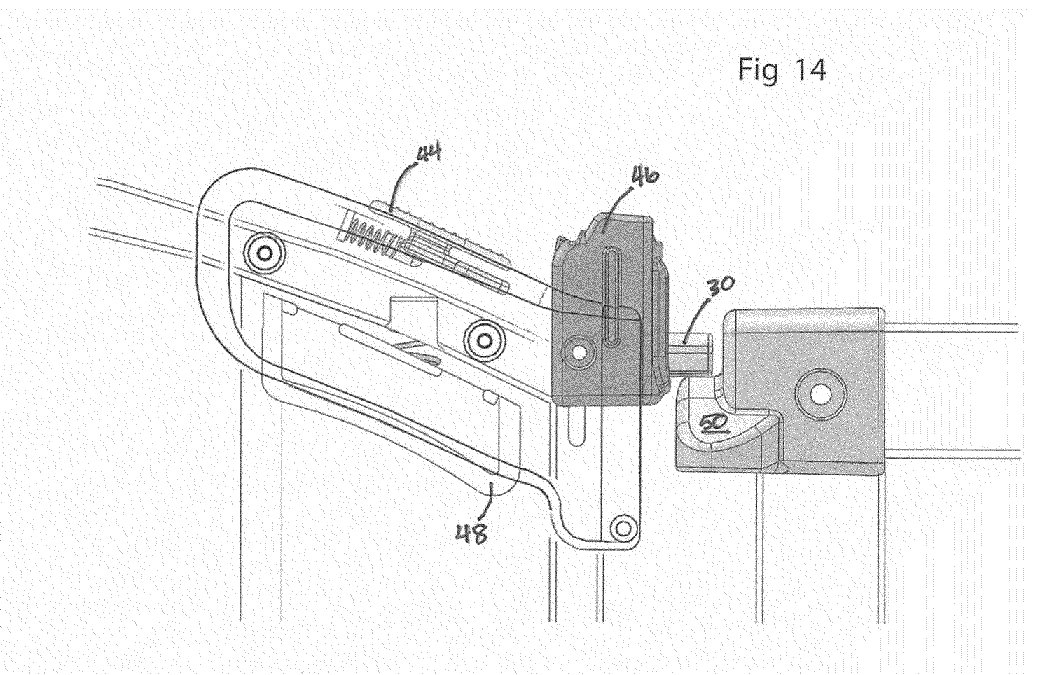

Although the safety gate 10 may be opened with the release mechanism 34 and without the use of the hands, embodiments of the present invention also include a hand release mechanism 28 on top of the gate 10 so that an individual may unlock the gate by hand without using the release mechanism 34. FIGS. 11 and 12 schematically show perspective and front views, respectively, of the upper latch mechanism 24 with the hand release mechanism 28 in the locked position, and FIGS. 13 and 14 schematically show the upper latch mechanism 24 in the unlocked position. As shown, the hand release mechanism 28 includes a spring loaded slider 44 that moves from a locked position (as shown in FIGS. 11 and 12) to a released or unlocked position (as shown in FIGS. 13 and 14). The hand release mechanism 28 also includes the rod 30 that engages the corresponding groove 32, a carriage 46 that holds the rod 30, and a spring loaded actuator 48 that is movably coupled to the carriage 46. The spring loaded slider 44 includes a tab 44a that prevents the carriage 46 from being able to move in a substantially vertical direction when the spring loaded slider 44 is in the locked position, as shown in FIG. 11. The rod 30, however, is configured to move independently within the carriage 46 so that the rod 30 is able to move in a substantially vertical direction regardless of whether the spring loaded slider 44 is in the locked or unlocked position.

When opening the gate 10, the spring loaded slider 44 is moved to the unlocked or released position which moves the tab 44a away from the top of the carriage 46. The spring loaded actuator 48 is then lifted up or moved toward the top of the gate 10 causing the carriage 46 to move in an upward or substantially vertical direction, as shown in FIGS. 13 and 14. The carriage 46 is also operably coupled to a similar carriage 46a in the lower latch mechanism 24 which moves in an upward or substantially vertical direction similar to carriage 46. As the carriages 46, 46a move upward, the rods 30 also move upward and out of the corresponding grooves 32, releasing the latch mechanisms 24, 26 and allowing the door 14 to be pushed open. A load is applied to the spring 40 in the release mechanism 34 as the door 14 is opened, causing the door 14 to return to the closed and locked position once the door is no longer being pushed or held open.

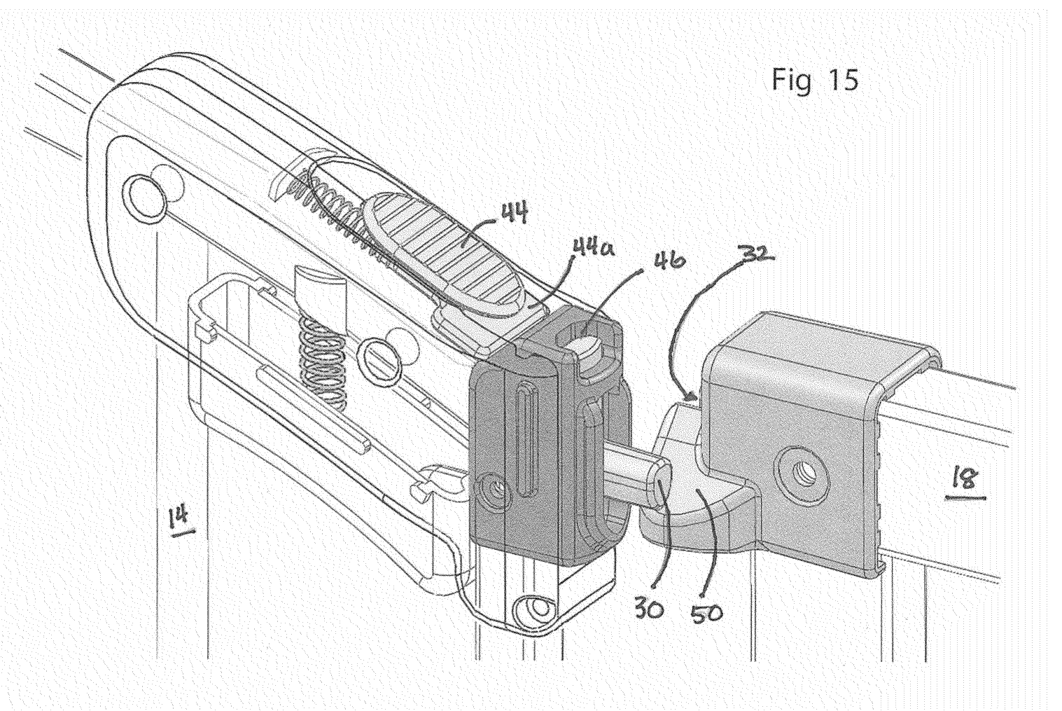

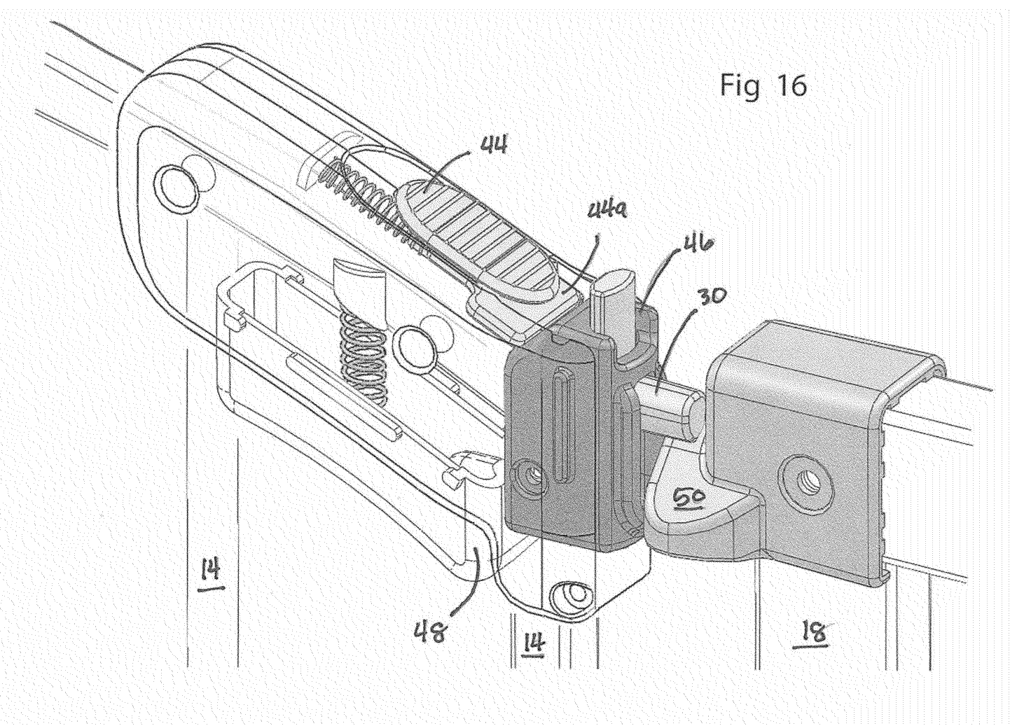

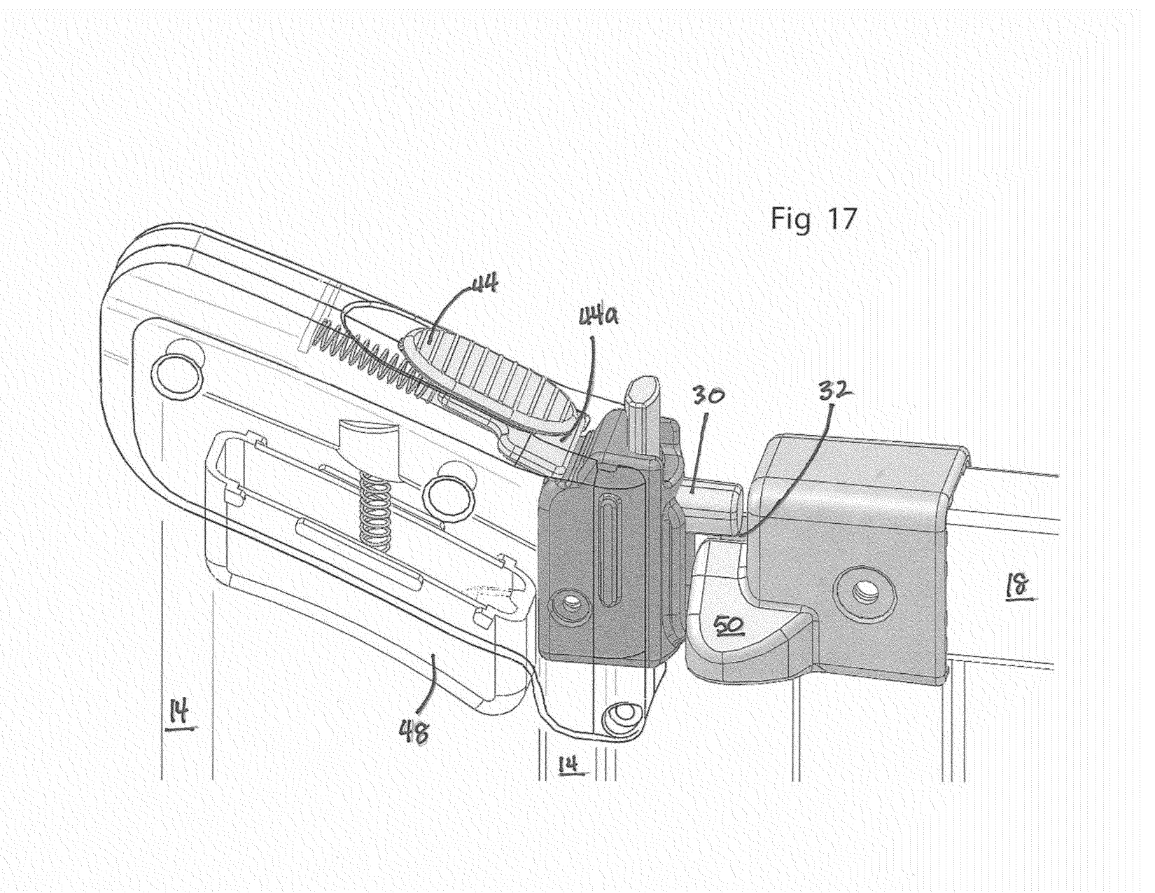

FIGS. 15-17 schematically show a perspective view of the upper latch mechanism 24 during the gate closing process. As the door 14 is closing, the rod 30 initially contacts a ramp 50 that is disposed on either side of the groove 32, such as shown in FIG. 15. The force of the spring 40 and the motion of the door 14 as it swings closed causes the rod 30 to move along the ramp 50 toward the groove 32 which moves the rod 30 in a substantially vertical direction within the carriage 46, such as shown in FIG. 16. Once the rod 30 reaches the top of the ramp 50, the rod 30 moves into the groove 32. FIG. 17 shows an exaggerated view of the rod 30 placement right before the rod 30 moves into the groove 32. Although not shown, the lower latch mechanism 26 works in a similar fashion as described above with respect to the upper latch mechanism 24

Embodiments of the safety gate 10 allow the gate to be opened using the foot pedal in a hands-free operation and also opened by hand using the hand release mechanism 28. Although the above discussion discloses various exemplary embodiments of the invention, it should be apparent that those skilled in the art can make various modifications that will achieve some of the advantages of the invention without departing from the true scope of the invention. For example, the release mechanism 34 may be mounted toward the floor, as shown, or toward the middle or upper end of the gate (not shown) and actuated by applying a sufficient force (e.g., pressing a knee or hip) to the pedal 36. Also, the foot pedal 36 is shown as being depressed, but the foot pedal 36 may be actuated in any direction, e.g., pressed down, raised up, moved sideways. The door 14 may also be moved in either a substantially upward (as shown) or substantially downward vertical direction when moving to the released position.

What is claimed is:

1. A child safety gate comprising:
a frame having a first side configured to be removably mounted to one side of a passageway and a second side configured to be removably mounted to an opposing side of the passageway;
a door pivotably coupled to the first side of the frame and releasably coupled to the second side of the frame; and
a release mechanism including a foot pedal, the release mechanism coupled to the first side of the frame, pivotably coupled to the door, and configured to move the door from a closed and locked position to an open position when the foot pedal is sufficiently actuated.

2. The child safety gate of claim 1, wherein the door is releasably coupled to the second side of the frame by a latch mechanism.

3. The child safety gate of claim 2, wherein the latch mechanism further includes a hand release mechanism configured to move the door from the locked position to an unlocked position.

4. The child safety gate of claim 3, wherein the hand release mechanism includes a slider configured to move from a locked position to a released position, a rod configured to move in a substantially vertical direction, and an actuator movably coupled to the rod, wherein the actuator is permitted to move the rod in the substantially vertical direction when the slider is in the released position and the actuator is unable to move the rod in the substantially vertical direction when the slider is in the locked position.

5. The child safety gate of claim 1, wherein the release mechanism is configured to move the door in a substantially vertical direction so as to allow the door to go from the locked position to an unlocked position.

6. The child safety gate of claim 1, wherein the release mechanism further includes a spring configured to move the door from the open position to the closed and locked position.

7. The child safety gate of claim 1, wherein the frame further includes a connecting member configured to couple the first side to the second side of the frame, wherein the release mechanism is further coupled to the connecting member.

8. The child safety gate of claim 1, wherein the release mechanism further includes a second foot pedal disposed in an opposing direction from the foot pedal, the second foot pedal configured to move the door from the closed and locked position to the open position when the second. foot pedal is sufficiently actuated.

9. A child safety gate comprising:
a frame having a first side configured to be removably mounted to one side of a passageway and a second side configured to be removably mounted to an opposing side of the passageway;
a door pivotably coupled to the first side of the frame and releasably coupled to the second side of the frame; and
a release mechanism including a first foot pedal and a second foot pedal disposed in an opposing direction from the foot pedal, the release mechanism coupled to the first side of the frame, pivotably coupled to the door, and configured to move the door from a closed and locked position to an open position when either the first foot pedal or the second foot pedal is sufficiently actuated.
